(19) United States
(12) Patent Application Publication
(10) Pub. No.: US 2015/0248199 A1
(43) Pub. Date: Sep. 3, 2015

(54) SPLIT VIEW CALENDAR

(71) Applicant: Apple Inc., Cupertino, CA (US)

(72) Inventors: Stephen O. Lemay, Palo Alto, CA (US); Imran A. Chaudhri, San Francisco, CA (US); Tiffany S. Jon, Cupertino, CA (US)

(21) Appl. No.: 14/581,766

(22) Filed: Dec. 23, 2014

Related U.S. Application Data
(60) Provisional application No. 61/946,484, filed on Feb. 28, 2014.

(51) Int. Cl. G06F 3/0482; G06F 3/0485; G06F 3/0488; G06F 3/0484

(52) U.S. Cl. CPC G06F 3/0482; G06F 3/04842; G06F 3/0485; G06F 3/0488

(57) ABSTRACT

A calendar application of a computing device includes multiple views. The views of the calendar application include a split view. The split view divides a content region of the calendar application into a first content region portion and a second content region portion. A month view of the calendar application is displayed in the first content region portion and a list view of user events is displayed in the second content region portion.

### CROSS-REFERENCE TO RELATED APPLICATIONS

This application claims the benefit of U.S. Provisional Application No. 61/946,484, filed on Feb. 28, 2014, which is incorporated by reference in its entirety.

### BACKGROUND

1. Field of Technology

The embodiments generally relate to calendar applications. More particularly, the embodiments relate to user interface views of a calendar application that provide quick access to user event information.

2. Background

Conventional calendar applications generally show various arrangements of days, weeks, and months in a year. These calendar applications also provide user activity information to the users in the same view. However, conventional calendar applications present the views of the calendar and the user activity information in a manner that does not maximize display screen real estate.

### SUMMARY

In one embodiment, a calendar application includes a split view. The split view simultaneously displays both a month view including a month of the year and a list view of user events associated with a selected day in the month. The split view may be activated in response to a user selection of a split view affordance (e.g., a user interface element). The list view of user events represents the events as a series of rows, where each row is associated with a corresponding event. The height of the rows in the list view is uniform regardless of the duration of each user event. In one embodiment, the list view of events includes events of the current day although user events of other days may be displayed. The split view of the calendar application advantageously allows the user to view the user's events for a selected day in context with the days of the month in a manner that maximizes the display screen space of the computing device.

User input may be received in the month view to display another month in the split view. Responsive to the user input, a different month is displayed in the split view. The month view of the different month includes all weeks of the month. Furthermore, user input may be received in the list view of user events to browse through the user events. Responsive to the user input in the list view of events, at least one additional user event is displayed in the list view of events. Thus, the month view and list view of events included in the split view are both user interactable.

In one embodiment, a user selection of a day from the month view included in the split view is received. An animation is displayed to display a list view of events of the selected day responsive to the user selection. Alternatively, the list view of events is automatically updated to display a list view of events of the selected day rather than display the animation.

In one embodiment, a handle affordance (e.g., a user interface element) is displayed in the split view. The handle affordance may be displayed in the month view or the list view of user events of the split view. User input may be received that moves the position of the handle affordance. In response to the user input, the size of the month view and the list view of events included in the split view is changed based on the position of the handle affordance. If the position of the handle affordance is moved in a direction towards the month view past a predetermined threshold, only the current week of the month is displayed in the month view. The current week of the month can be horizontally scrolled responsive to receiving a user input in the month view to view other days of the weeks of the month.

In one embodiment, the calendar application also includes a day view. The day view displays user events of a selected day. The day view of events is organized into rows where each row is associated with a corresponding event from the day view. However, unlike the list view of events, a size of each row in the day view is based on a duration of the event. Furthermore, a distance between a pair of events in the day view is based on a duration of time between the pair of events.

When the day view is displayed, the split view affordance is replaced with a list view affordance. User selection of the list view affordance replaces the day view of user events for the selected day with a list view of user events for the selected day. In one embodiment, a handle affordance is displayed that can be used to toggle between the day view of user events and the list view of user events. The handle affordance can be used to toggle between the day view and list view rather than the list view affordance. When the day view of user events is initially displayed, the list view of user events replaces the day view responsive to user input moving the position of the handle affordance past a predetermined threshold and vice versa.

In one embodiment, the calendar application includes a calendar setting to display a month view in the day view of events. If the calendar setting is activated and a day from the month view of the calendar application is selected, all weeks of the month are displayed along with a day view of the user events of the selected day.

In one embodiment, the list view of user events is persistent across the computing device including the calendar application. If the list view of user events is activated in the calendar application, other views of the computing device may also display a list view of events. For example, the computing device may include a notification view that summarizes information for the user such as the weather, driving directions, and user events. If the list view of events is activated in the calendar application, the notification view of the computing device displays user events in the list view format.

Note that the various embodiments of the calendar application described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1A is a high-level block diagram of a computing device according to one embodiment.

FIG. 1B is a high-level block diagram of a calendar application according to one embodiment.

FIG. 2 is a user interface of the calendar application indicating different regions of the calendar application according to one embodiment.

FIG. 3 is a month view user interface of the calendar application according to one embodiment.

FIG. 4 is a day view user interface of the calendar application according to one embodiment.

FIGS. 5A, 5B, and 5C are split month view user interfaces of the calendar application according to one embodiment.

FIG. 6 is a split view user interface of the calendar application illustrating swipe functionality according to one embodiment.

FIGS. 7A, 7B, and 7C are split view user interfaces of the calendar application according to another embodiment.

FIG. 8 is a split view user interface of the calendar application according to another embodiment.

FIG. 9 is a list view user interface of the calendar application according to one embodiment.

FIG. 10A is a day view user interface of the calendar application according to another embodiment.

FIG. 10B is a list view user interface of the calendar application according to another embodiment.

FIG. 11A is a calendar settings user interface of the calendar application according to one embodiment.

FIG. 11B is a split view user interface of the calendar application based on the settings of the calendar application shown in FIG. 11B according to one embodiment.

FIG. 11C is a split view user interface of the calendar application based on the settings of the calendar application shown in FIG. 11B according to one embodiment.

FIG. 12 is a list view user interface of the calendar application including search functionality according to one embodiment.

FIG. 13A is list view user interface of the calendar application including search functionality according to another embodiment.

FIG. 13B is day view user interface of the calendar application including search functionality according to another embodiment.

FIG. 14 is a notification center user interface of the computing device according to one embodiment.

FIG. 15 is a method flow diagram for displaying a split view of the calendar application according to one embodiment.

FIG. 16 is a method flow diagram for displaying a split view of the calendar application according to another embodiment.

FIG. 17 illustrates a high-level block diagram illustrating a typical computer for acting as the computing device according to one embodiment.

The figures depict, and the detail description describes, various non-limiting embodiments for purposes of illustration only. One skilled in the art will readily recognize from the following discussion that alternative embodiments of the structures and methods illustrated herein may be employed without departing from the principles described herein.

### DETAILED DESCRIPTION

A calendar application is provided on a computing device of a user. The calendar application includes a number of different graphical user interface (GUI) views. The GUI views include a hierarchy of calendar views including a year view, a month view, a day view, and a list view as will be further described below. The hierarchy of calendar views describes the arrangement of the calendar views from top to bottom: the year view followed by the month view followed by the day view/list view. In one embodiment, each calendar view may be optimized for portrait or landscape presentation on the computing device.

The year view of the calendar application displays the twelve months of a calendar year and the days included in each month. In contrast, the month view of the calendar application displays the days in a given month. The month represented in the month view may be the current month of the calendar year or a month selected by the user.

Furthermore, the day view of the calendar application displays a list of the user's events for a selected day. User events may include entries in the user's calendar such as appointments, meetings, etc. In one embodiment, the day view displays each event from the list of user events for a given day as a row where the height of each row represents the duration of the associated event, with events having longer durations being shown in rows of greater height. Furthermore, the calendar application includes a list view that displays the user's events for a given day in a uniform format where the heights of the rows are fixed and uniform, regardless of the duration of the underlying events.

In one embodiment, the calendar application also includes a split view that simultaneously displays the month view of a month and the list view of user events for a selected day in the month as will be further described below. The split view of the calendar application advantageously allows the user to view the user's events for a selected day in context with the days of the month in a manner that maximizes the display screen space of the computing device.

### Computing Device

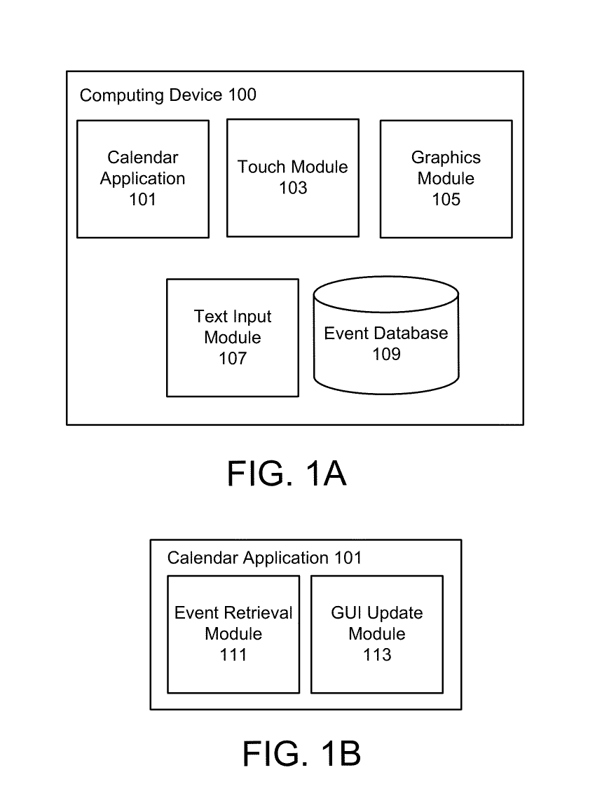

FIG. 1A is a high-level block diagram of a computing device 100. In one embodiment, the computing device 100 is an electronic device such as a desktop computer (e.g., an Apple iMac™), a laptop computer (e.g., Apple MacBook™), a tablet computer (e.g., Apple iPad™), a mobile phone (e.g., Apple iPhone™), a media device (e.g., Apple iPod™), etc. In the embodiments disclosed herein, the computing device 100 is described as an electronic device including a touch screen such as a mobile phone or tablet computer. However, other computing devices lacking a touch screen can be used according to the embodiments disclosed herein.

As shown in FIG. 1A, the computing device 100 includes a calendar application 101, a touch module 103, a graphics module 105, a text input module 107, and an event database 121 according to one embodiment. As is known in the art, the term “module” refers to computer program logic utilized to provide the specified functionality upon execution by the computing device 100. Other embodiments of the computing device 100 can have different and/or other modules than the ones described here, and that the functionalities can be distributed among the modules in a different manner.

The calendar application 101 includes computer executable instructions to create, display, modify, and store calendars and data associated with calendars based on user instructions. The data associated with the calendars include user events provided by the user of the computing device 100 such as any calendar entries including appointments, meetings, sporting events, etc. A user event may also be provided by another person that invited the user to accept the event.

The touch module 103 detects one or more touch points with a touch screen (hereinafter “display screen”) of the computing device 100 (“touch point” as used herein is understood to include the plural “touch points”). The touch module 103 receives touch data from the display screen and determines movement of the touch point based on speed, velocity, pressure, and/or an acceleration of the contact point, and tracks the movement across the display screen. The touch module 103 determines if the touch has stopped such as the detection of a finger-up event or a break in contact with the display screen. These operations may be applied to a single touch (e.g., one finger touch) or to multiple simultaneous touches.

The touch module 103 detects a gesture input by a user on the computing device 100. Different gestures have different touch patterns. A touch pattern is characterized by one or more touch points and their associated movements, from which the spatial or geometrical relationships between the touch points can be determined. The touch module 103 detects a gesture based on a particular touch pattern on the display screen. For example, the touch module 103 detects a finger tap gesture by detecting a finger-down event indicating an initial touch of a position on the display screen followed by detecting a finger-up event at substantially the same position where the finger is no longer touching the touch screen. In another example, the touch module 103 detects a finger swipe gesture on the touch screen based on detecting a finger-down event (appearance of a touch point) followed by detecting one or more finger-dragging events where the user drags his or her finger from the position associated with the finger-down event to another position on the display screen (movement of a touch point), and subsequently followed by a finger-up event (disappearance of the touch point).

The graphics module 105 renders and displays graphics on the display screen of the computing device 100. In one embodiment, the term “graphics” includes any object that can be displayed to the user. For example, graphics include text, web pages, icons including user-interface objects including soft keys, digital images, videos, animations, and the like. The graphics module 105 receives display information (e.g., data) from the calendar application 101 that represents graphics of the calendar application 101 to display on the computing device 100. The graphics for display on the computing device 100 include the different views of the calendar application 101 as described above. The graphics module 105 generates screen image data for output on the display screen of the computing device 100 based on the display information received from the calendar application 101.

The text input module 107 provides a mechanism for entering text. In one embodiment, the text input module 107 provides a soft keyboard for entering text in the calendar application 101. The text input module 107 receives text entered via the soft keyboard and provides the text to the calendar application 101. For example, the text input module 107 may receive one or more of a description, a start time, an end time, and location information of calendar entries for storage as calendar events.

The event database 109 stores calendar entries as calendar events for the calendar application 101. As mentioned previously, events may include user entries in the user's calendar such as appointments, meetings, etc. Each user event includes at least a textual description of the event, date (or date range) and optionally a start time and an end time of the event. The event may also indicate a location where the event is to take place such as an address, a conference room name, a conference room number, etc. Additional metadata may be associated with an event, such as category labels, privacy type, priority, recurrence properties, reminder type, and so forth.

Referring to FIG. 1B, a detailed view of the calendar application 101 is shown according to one embodiment. The calendar application 101 includes an event retrieval module 111. The event retrieval module 111 retrieves user events from the event database 109 for display on the computing device 100. The event retrieval module 111 may retrieve events from the event database 109 in response to a request from the user to view the user events of a particular day(s).

The calendar application 101 also includes a GUI update module 113. The GUI update module 113 prepares display information and sends the display information to the graphics module 105 for display on the computing device 100. In one embodiment, the GUI update module 113 prepares graphics corresponding to different calendar views requested by the user and sends the graphics to the graphics module 105 for display on the computing device 100.

### Calendar UI

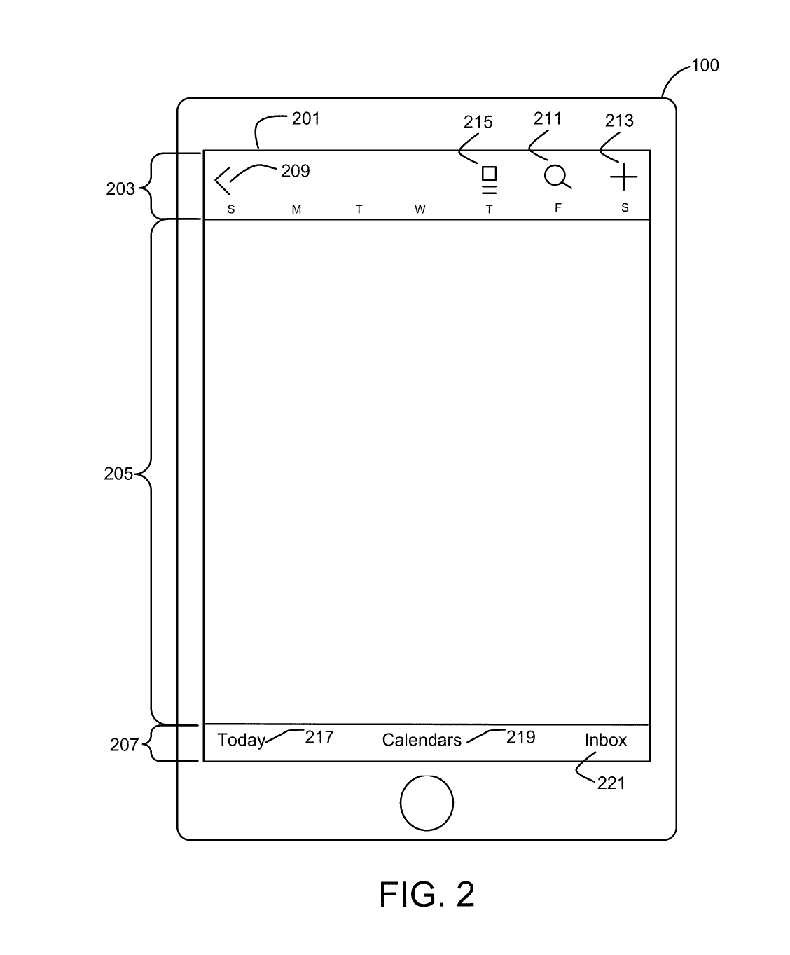

FIG. 2 is a user interface of the calendar application 101 indicating different regions of the calendar application 101 that are displayed on a display screen 201 of the computing device 100. In one embodiment, the calendar application 101 includes three regions: a first control region 203, a content region 205, and a second control region 207. The content region 205 displays the calendar views of the calendar application 101. As shown in FIG. 2, the content region 205 is displayed between the first control region 203 and the second control region 207. However, the content region 205, first control region 203, and second control region 207 may be displayed in other positions than those described herein.

The first control region 203 and the second control region 207 each include multiple, interactive user interface (UI) elements (i.e., affordances). Note that in other embodiments, different UI elements may be included in the first control region 203 and the second control region 207 than those described herein. Each UI element is associated with a particular calendar functionality. For example, the first control region 203 includes a back UI element 209 (hereinafter referred to as a “back button”). The back button 209 is persistent across all calendar views of the calendar application 101. In general, user selection of the back button 209 causes the computing device 100 to update the content region 205 of the display screen 201 to display a calendar view that is higher than the currently displayed calendar view in the calendar hierarchy, except when the year view is displayed in the content region 205, since the year view is at the top of the calendar view hierarchy.

The back button 209 may have a label that graphically or textually conveys calendar information. The calendar information may indicate the prior calendar view in the calendar hierarchy, e.g., by showing a text or icon indicative of the prior calendar view. The type of information conveyed by the back button 209 is dependent on what calendar view is currently displayed in the content region 205 as will be further described below.

The first control region 203 also includes a search UI element 211 (hereinafter referred to as a “search button”) and an add UI element 213 (hereinafter referred to as a “add button”). The search button 211 and the add button 213 are persistent across all calendar views of the calendar application 101 in one embodiment. However, the search UI element 211 may be omitted from the first control region 203 in other embodiments as will be described below.

The search button 211 is associated with search functionality of the calendar application 101. A search user interface may be displayed in the content region 205 that allows the user to provide a search query for a user event(s) pertaining to the search query responsive to user selection of the search button 211. The add button 213 is associated with the addition of calendar entries to the user's calendar via a UI displayed in the content region 205 responsive to user selection of the add button 213.

As shown in FIG. 2, the first control region 203 also includes a split view UI element 215 (hereinafter referred to as a “split view button”). The split view button 215 is not persistent across all calendar views of the calendar application 101. In one embodiment, the split view button 215 is displayed only when the content region 205 displays the month view of the calendar application 101. Alternatively, the split view button 215 may be displayed in the year view and month view of the calendar application 101. As will be further described below, responsive to user selection of the split view button 215, the content region 205 is divided into multiple portions that each display either a month view or a day view/list view of the calendar application 101.

The second control region 207 includes a today UI element 217 (hereinafter referred to as a “today button”), a calendars UI element 219 (hereinafter referred to as a “calendars button”), and an inbox UI 221 (hereinafter referred to as an “inbox button”). The calendars button 219 is associated with calendar settings of the calendar application 101. The calendar settings are displayed in the content region 205 responsive to user selection of the calendars button 219 as will be further described below. The inbox button 219 is associated with any calendar invites received by the user of computer device 100. Lastly, user selection of the today button 217 causes the computing device 100 to display the current day in the context of the calendar view displayed in the content region 205 as will be further described below.

### Calendar UI: Month View

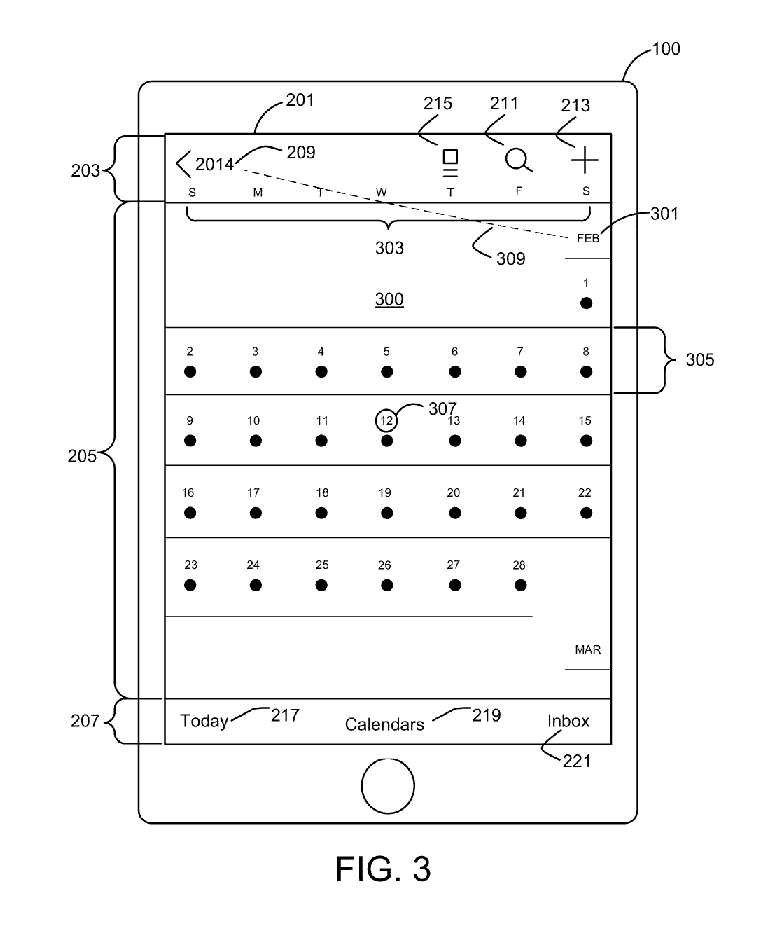

Referring now to FIG. 3, one embodiment of a month view 300 of the calendar application 100 is displayed in the content region 205 of the display screen 201. The month view 300 displays the days of a given month. The month represented in the month view 300 may be the current month or a month selected by the user of the computing device 100. In the example shown in FIG. 3, the month of February 2014 is displayed in the content region 205 as indicated by label 301. The days of the month are organized into a series of rows where each row represents one week in the month. The days of each week in the month are ordered based on the seven days of the week 303 (e.g., Sunday, Monday, Tuesday, etc.). For example, row 305 includes days 2 through 8 of February. The position of each day in row 305 indicates what day of the week 203 that the particular day falls on.

As mentioned previously, the back button 209 visually conveys information to the user indicating the prior calendar view in the calendar hierarchy, which prior calendar view will be displayed in the content region 205 responsive to user selection of the back button 209. In the month view 300, the back button 209 indicates the year to which the displayed month belongs thereby indicating if the back button 209 is selected, the year view will be displayed in the content region 205. In the example shown in FIG. 3, the back button 209 indicates the year “2014.” When in the month view 300 as shown in FIG. 3, user selection of the back button 209 causes the computing device 100 to update the content region 205 to display the year view of the calendar application 101.

If the content region 205 displays the current month in the month view 300, content region 205 includes an indication 307 of the current day. The indication 307 may be a circle around the current day as shown in FIG. 3 or any other visual indicator that highlights the current day. If the month view 300 displays a month other than the current month, the indication 307 is not displayed in the content region 205.

As mentioned previously, the second control region 205 includes a today button 217. User selection of the day button 217 causes the computing device 100 to display the current day in the context of the calendar view displayed in the content region 205. In one embodiment, the current day is displayed via an animation responsive to selection of the today button 217. The animation may be a “scroll” animation illustrating scrolling of the content in the content region 205 or a “snap back” animation where the content region 205 is automatically updated with the current day in the context of the calendar view. The computing device 100 selects which animation is used to update the content region 205 based on the duration of time from the current day to the current view in the content region 205 with respect to a threshold distance. In the month view 400 of the calendar application 101, if the current month is not displayed in the content region 205, user selection of the today button 217 causes the computing device 100 to update the content region 205 with the current month via either the scroll animation or the snapback animation based on a threshold distance (e.g., 3 months).

In one embodiment, the month view 300 is user interactable. The computing device 100 may receive an input from the user instructing the computing device 100 to scroll through the month view 300. Scrolling through the month view 300 causes the content region 205 to display days of different months of the year. The specific days of the month that are displayed in the content region 205 are based on the direction of the input of the user. For example, if the computing device 100 receives an instruction to scroll up, for example from a “swipe-up” gesture, the computing device 100 may display an animation of the month view 300 scrolling to the next month. If the computing device 100 receives an instruction to scroll down, for example from a “swipe-down” gesture, the computing device 100 may display an animation of the month view 300 scrolling to the previous month. The scrolling of the month can be a month at a time (e.g., paging through months), or by scrolling a week at a time.

Furthermore, the user may interact with the month view 300 by selecting a day of the month. Responsive to receiving a selection of a day of the month, the computing device 100 updates the content region 205 to display a day view.

### Calendar UI: Day View

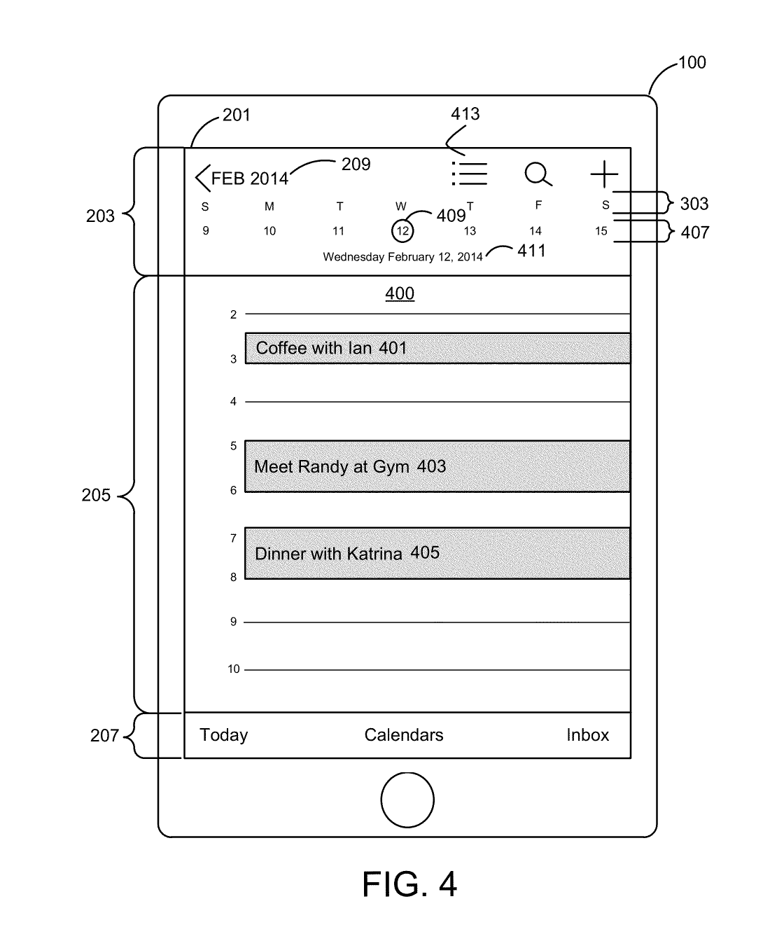

FIG. 4 is one example of a day view 400 of the calendar application 101. As shown in FIG. 4, the content region 205 is updated to display the day view 400 responsive to selection of a day in the month. In the shown example, the day view 400 includes the user's events 401, 403, and 405 on Feb. 12, 2014 where each event is represented by a corresponding row.

As shown in FIG. 4, the day view 400 includes the times of the day and each event during particular times of the day. In the day view 400, each event is represented by a visually distinguished row, and the duration of each event is visually indicated by the height of the row that represents the event. For example, event 401 is scheduled from 2:30 pm to 3:00 pm whereas event 405 is scheduled from 7 pm to 8 pm. Thus, the height of the row associated with event 401 is half the size of the row associated with event 405 since the duration of event 401 is half the duration of event 405. Gaps are shown between the rows representing different events, indicating that those time periods do not have any scheduled events.

Furthermore, the first control region 203 is updated responsive to the computing device 100 receiving the selection of a day of the month in the month view 300. As shown in FIG. 4, the back button 209 now indicates the month and year (e.g., FEB 2014) that includes the selected day. Additionally, the first control region 203 is updated to include the days of the week 407 that include the selected day, where each day of the week has a corresponding label 303. The selected day is highlighted in the days of the week 407 by indicator 409. The first control region 203 also includes a textual description 411 of the day of the week and the date of the selected day. As shown in FIG. 4, the textual description 411 states “Wednesday Feb. 12, 2014.” The first control region 203 is also updated to replace the split view button 215 with list view UI element 413 (hereinafter referred to as the “list view button”) responsive to the computing device 100 receiving the user selection of a day of the month. User selection of the list view button 413 causes the computing device 100 to update the content region 205 with a list view of events rather than the day view of events as will be further described below.

### Calendar UI: Split View

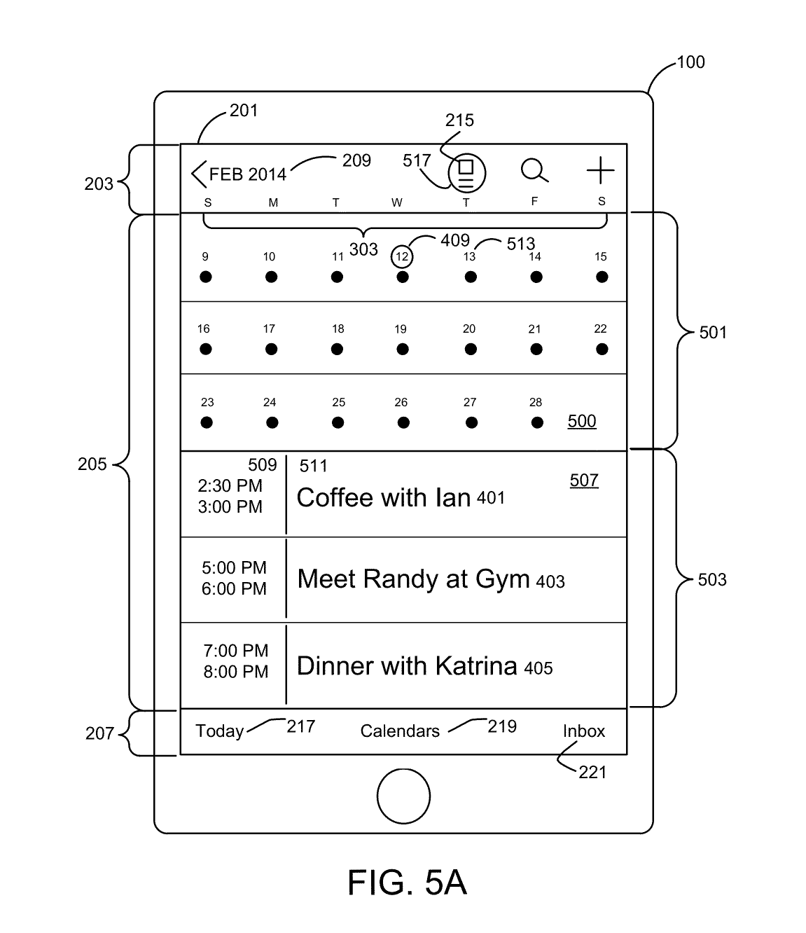

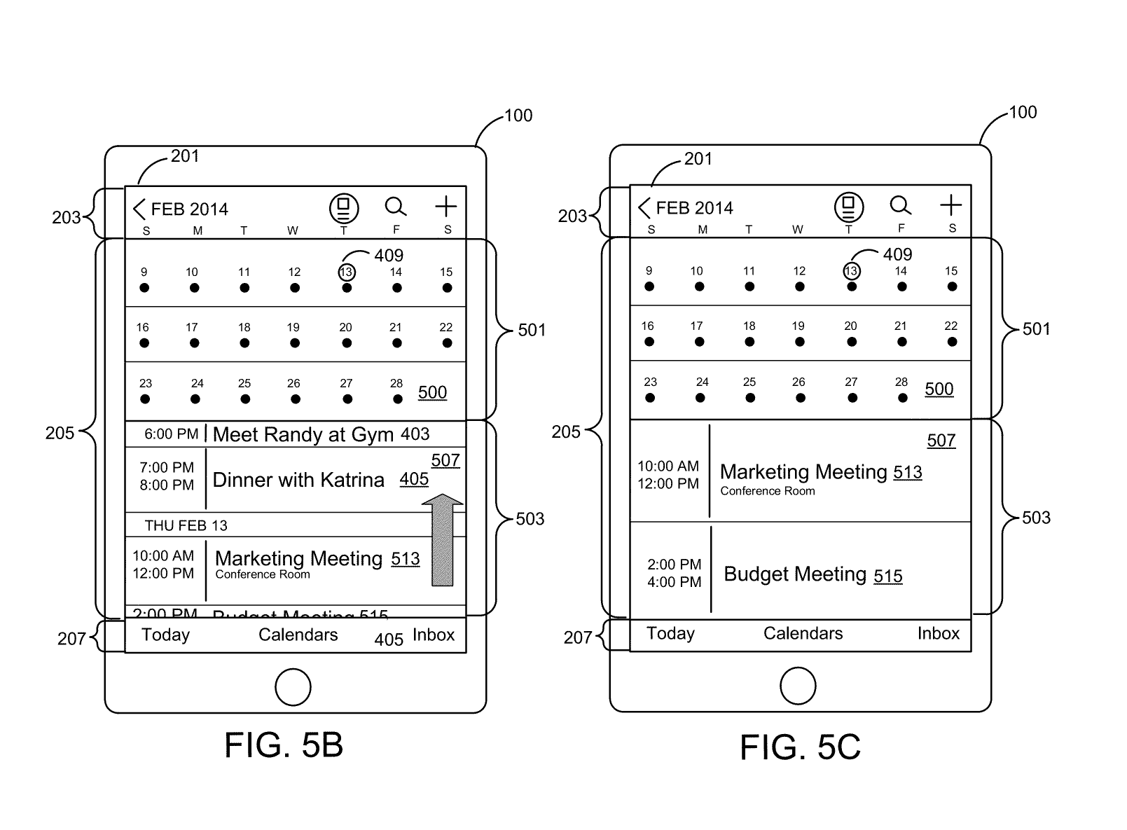

Referring back to FIG. 3 illustrating the month view 300, a user selection of the split view button 215 causes the computing device 100 to update the content region 205 to display a split view. In one embodiment, a split view is a calendar view that includes both the month view and a list view of events of a selected day within the month. FIG. 5A is one example of a split view 500 of the calendar application 101. Responsive to user selection of the split view button 215, the computing device 100 divides the content region 205 into a first content region portion 501 and a second content region portion 503.

The first content region portion 501 displays the month view that was displayed in the content region 205 at the time when the split view button 215 was selected. In one embodiment, the computing device 100 modifies the month view to display only the current week of the month and the remaining weeks in the month in the first content region portion 501. For example, given that the selected day was Feb. 12, 2014 when the split view button 215 was activated, the first content region portion 501 displays the second, third, and fourth weeks of February, 2014, but not the first week. Alternatively, the computing device 100 displays all the weeks of the month in the content region portion 501.

The second content region portion 503 displays a list view of events 507 of a day from the month displayed in the first content region portion 501. In one embodiment, the computing device 100 automatically displays by default the list of events of the day of the month that was displayed in the content region 205 at the time when the split view button 215 was selected. However, the second content region portion 503 may display a list view of events of any day of the month selected by the user.

In one embodiment, the computing device 100 formats the height of the first content region portion 501 and the second content region 503 based on the height of the first content region portion 501 needed to display the month view. The computing device 100 collapses the rows of the month view such that only the current week of the month as well as the remaining weeks of the month are displayed in the first content region portion 501. The remaining area of the display screen 201 is used as the second content region portion 503 that displays the list of events for a selected day. Alternatively, the computing device 100 formats the display screen 2011 so that the first content region portion 501 and the second content region portion 503 are of equal size.

In one embodiment, the computing device 100 allocates the remaining area of the content region 205 that is not used to display the first content region portion 501 to the second content region portion 503. The computing device 100 determines whether all the events from the list for the selected day can fit in the second content region portion 503 while maintaining a minimum size, such as a minimum height or minimum font size, for each event description. If the computing device 100 determines that all the events of the day can be displayed with the minimum size, the second content region portion 503 includes all of the events of the day in the second content region portion 503. However, if the computing device 100 determines that all the events of the day cannot be displayed with the minimum size, the second content region portion 503 initially displays only includes the maximum number of events from the list of events that can be displayed with the minimum size. The user may browse through the list view of events in the second content region portion 503 to view the other events that are not initially shown in the second content region portion 503.

Similar to the day view 400, the list view of events 507 displayed in the second content region portion 503 includes the events on the selected day. Each event is represented by a corresponding row. Each row includes a time portion indicating the start time and end time of the event represented by the row. The time portion may also indicate if the event is an all day event. The time portion for multiple rows may indicate overlapping start time and end times of events if the events are overlapping in time. Each row also includes a description portion indicating a description of the event. The description portion may also include other information such as a location of the event. For example, in FIG. 5A the row representing event 401 includes a description portion 511 indicating the event “Coffee with Ian” and the time portion 509 indicates a start time of the event as 2:30 PM and an end time of 3:30 PM for the event. Although not shown in FIG. 5A, the description portion 511 may indicate the status of the event indicating whether the event has been confirmed by any invitees or is tentative.

However, unlike the day view, the rows in the list view of events 507 all have the same height regardless of the duration of the events. For example, the row representing event 401 is associated with an event with a duration of 30 minutes, but is the same height as the rows representing events 403 and 405 which are both associated with events with a duration of one hour. Thus, the list of events 507 is uniform in that each event does not visually indicate the duration of an associated event using the height of its corresponding row. Furthermore, unlike the day view, the list of events 507 is a continuous series of rows in that there are no visual gaps between events that indicate duration of time between pairs of events whereas during the day view, the computing device 100 visually indicates the duration of time between events based on the size of the gaps between events.

In one embodiment, the month view displayed in the first content region portion 501 and the list of events 507 displayed in the second content region portion 503 are independently scrollable. The user can browse through events of different days in the second content region portion 503 by scrolling up or down in this region 503, and is not limited to viewing the list of events of the selected day highlighted by the indicator 307 in the first content region portion 501. If the computing device 100 receives a selection of an event displayed in the second content region portion 503, the content region portion 205 is updated to display the details of the event. The details of the event include one or more of the name of the event, the date of the event, the start time of the event, the end time of the event, a location of the event, alert settings associated with the event, other people invited to the event, and a status of the invitation (e.g., accepted, declined, tentative, unanswered).

Similarly, the user can browse through different months of the year in the first content region portion 501 while maintaining the list of events 507 displayed in the second content region portion 503. The computing device 100 automatically displays in the first content region portion 501 the month before or the month after the month currently displayed in the first content region portion 501 based on the direction of the user input in the first content region portion 501, for example scrolling up (previous month) or down (next month) such as input by swipe down or a swipe up gestures, or alternatively scrolling left (previous month) or right (next month) such as input by a swipe right or swipe left gestures. In one embodiment, the computing device 100 displays the month in the first content region portion 501 such that all the weeks of the month are displayed responsive the user input in the first content region portion 501 to view a different month. Since the month is displayed in its entirety, the computing device 100 resizes the second content region portion 503 to accommodate displaying the entire month in the first content region portion 501.

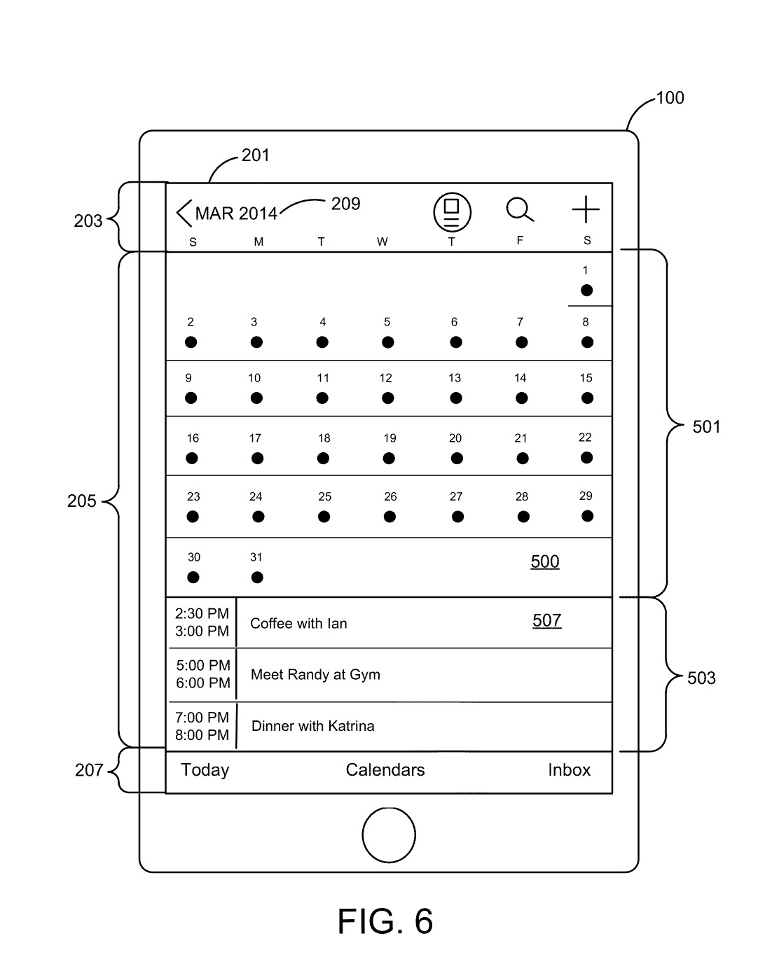

For example, if the user inputted a scroll down input (e.g. swipe up gesture) on the first content region portion 501, the computing device updates the first content region portion 501 to display the month of March as shown in FIG. 6. The computing device updates the back button 209 to display “MAR 2014” and also resizes the second content region portion 503 to accommodate the display of the entire month of March in the first content region portion 501.

Referring back to FIG. 5A, in one embodiment the computing device 100 updates the second content region portion 503 with a list of events from a different day responsive to the user selecting the day from the first content region portion 501. The computing device 100 may update the second content region 503 by displaying a scroll animation of the list of events in either the up or down direction based on whether the selected day is before or after the currently selected day.

Consider the example where the user selects “February 13” 513 from the month view displayed in the first content region portion 501 of the split view 500 shown in FIG. 5A. As shown in FIG. 5B, the first content region portion 501 is updated so that indicator 409 indicates the selected day of “February 13.” Furthermore, the second content region 503 displays an animation of the list view of events 507 scrolling upwards as indicated by the arrow. As the list view of events 507 scrolls upwards, event 401 from the previously selected day (e.g., February 12) is no longer displayed in the second content region portion 503. As shown in FIG. 5B, only events 403 and 405 are displayed in the second content region portion 503. However, as the list view of events 507 scrolls upward, a list view of events for the selected day “February 13” begins to display in the second content region portion 503. The animation stops once the events of the selected day are displayed in the second content region portion 503. For example, in FIG. 5C the scroll animation stopped once events 513 and 515 of Feb. 13, 2014 are displayed in the second content region portion 503.

As mentioned previously, the back button 209 displays the year of the selected month and the label 301 indicates the name of the month depicted in the month view 300 as shown in FIG. 3. Responsive to user selection of the split view button 215, the computing device 100 displays an animation showing the label 301 moving to the back button 209 so that the back button displays the month indicated by the label 301 and the year. For example, FIG. 3 includes a dotted line 309 indicating the path of travel of the label 301 towards the back button 209 and FIG. 5A displays the back button 209 including the label “FEB 2014” responsive to the user selection of the split view button 215 in FIG. 3. The animation may illustrate the label 301 moving with a constant velocity towards the back button 209 along the dotted line 309 or the animation may illustrate the label 301 accelerating towards the back button 209. Alternatively, the computing device 209 may automatically update the back button to display the month and the year without displaying an animation. Furthermore, the split view button 215 is highlighted responsive to user selection of the split view button 215 to indicate that the split view 500 is currently being displayed on the display screen 201. As shown in FIG. 5A, the split view button 215 is highlighted 517.

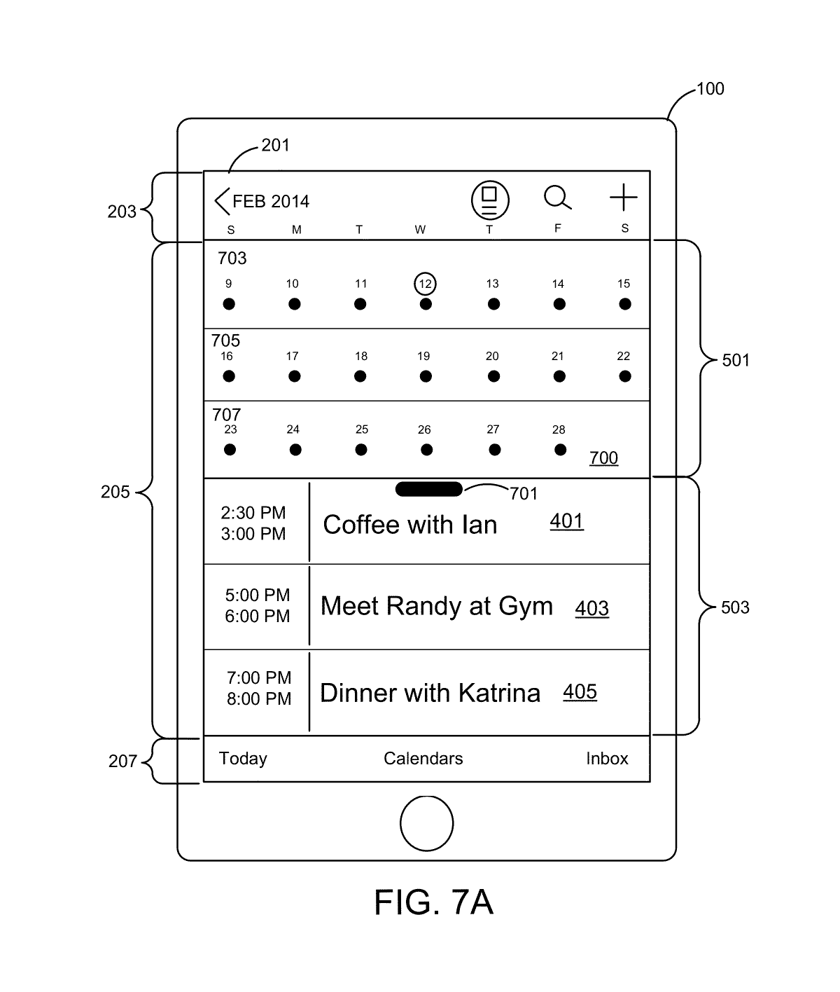

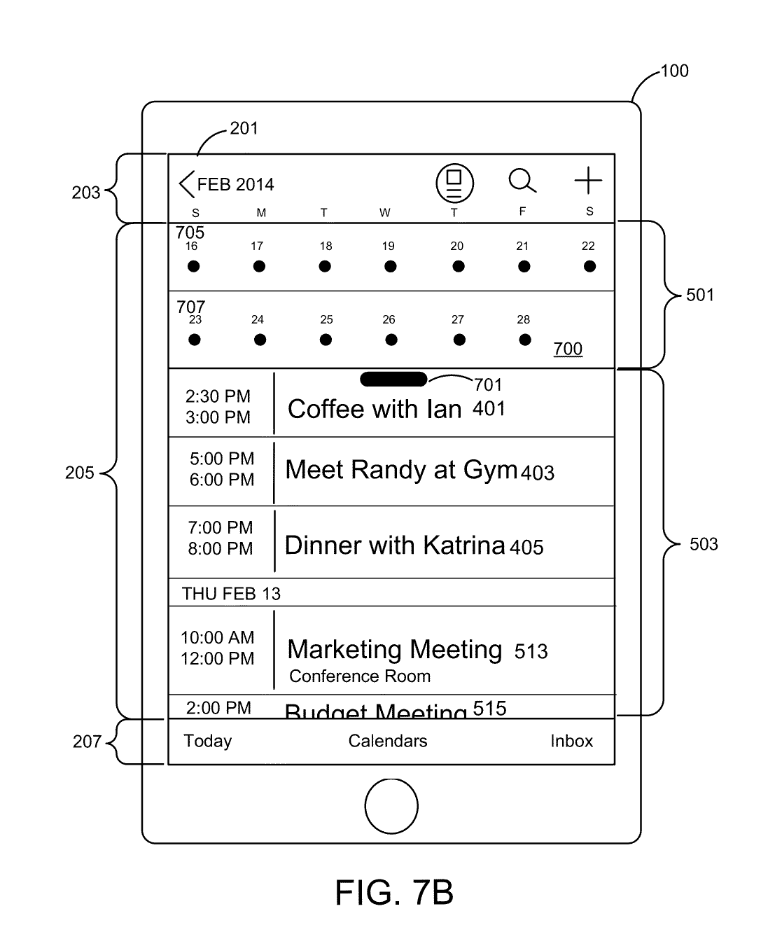

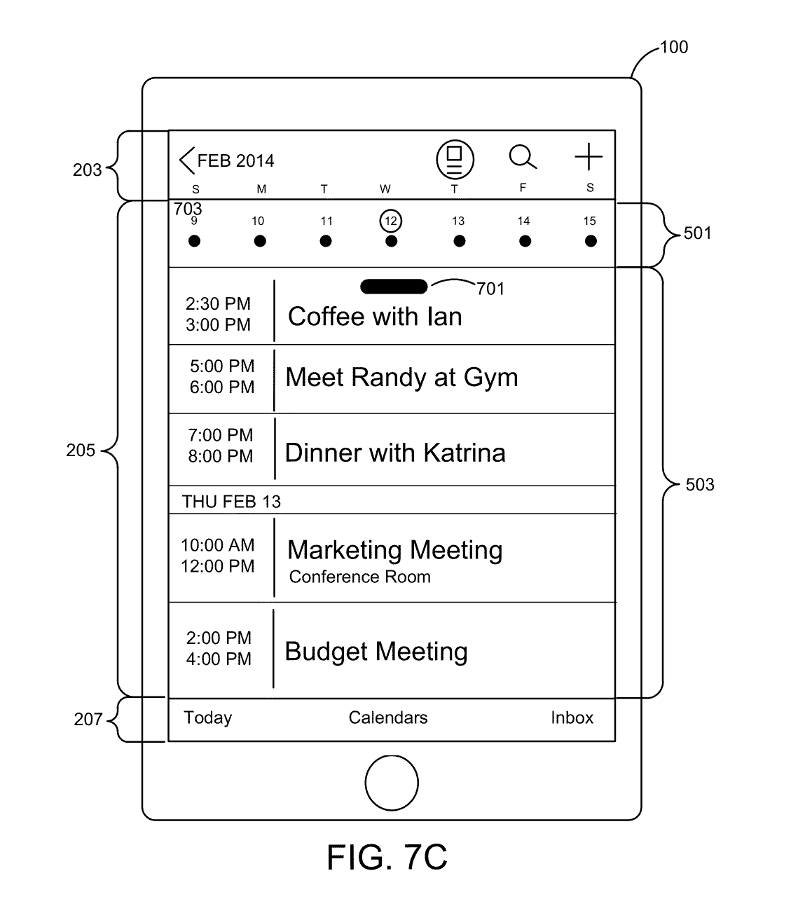

FIG. 7A is another embodiment of the split view 700 of the calendar application 101. In contrast to the split view 500, split view 700 includes a handle 701. As shown in FIG. 7A, the handle 701 is displayed in the second content region portion 503. However in other embodiments the handle 701 may be displayed in the first content region portion 501. The handle 701 is a UI element used by the user to adjust the size of the first content region portion 501 displaying the month view and the second content region portion 503 displaying the list view of events. The size of the first content region portion 501 and the second content region portion 503 is based on the magnitude and direction in which the handle 701 is moved. The user may select the handle 701 and move the handle 701 up thereby making the first content region portion 501 smaller and the second content region 503 larger. Conversely, the user may select the handle 701 and move the handle 701 down thereby making the first content region portion 501 larger and the second content region 503 smaller. The user may select the handle 701 either by a touch and drag gesture, or by an input device, such as a mouse or stylus.

In one embodiment, the bottom of the month view shown in the first content region portion 501 is attached to the top of the list view of events shown in the second content region portion 501. Thus, if the handle 701 is moved upwards, a top portion the month view also moves upwards as the first content region portion 501 decreases in size and the top portion of the month is eventually no longer displayed on the display screen 201 once the top portion moves past the top of the display screen 201. As the handle 701 is moved upwards, the top of the list view of events also moves upwards as the second content region portion 503 increases in size. As the second content region portion 503 increases in size, events from the next day or events from the same day that were not initially displayed in the second content region portion 503 are displayed in the second content portion region 503.

Similarly, if the handle 701 is moved downward, the bottom portion of the month view also moves downward as the first content region portion 501 increases in size. As the bottom portion of the month view moves downward, the days of the prior month begin to display in the first content region portion 501. As the handle 701 is moved downward, the top of the list view of events also moves downward as the second content region portion 503 decreases in size. As the second content region portion 503 decreases in size, events at the bottom of the list view of events are no longer displayed on the display screen 201 once the events at the end of the list view move past the bottom of the display screen 201.

As shown in FIG. 7A, the first content region portion 501 displays weeks 703, 705, and 707. The second content region portion 503 includes a list view of events 401, 403, and 405 for Feb. 12, 2014. If the handle 701 is moved upwards as shown in FIG. 7B, the first content region portion 501 decreases in size and only weeks 705 and 707 of the month view are displayed in the first content region 501. Thus, week 703 is no longer visible in the first content display region 501. As the handle 701 is moved upward, the second content portion region 503 also increases in size thereby displaying events 513 and 515 from the next day (e.g., Thursday, February 13).

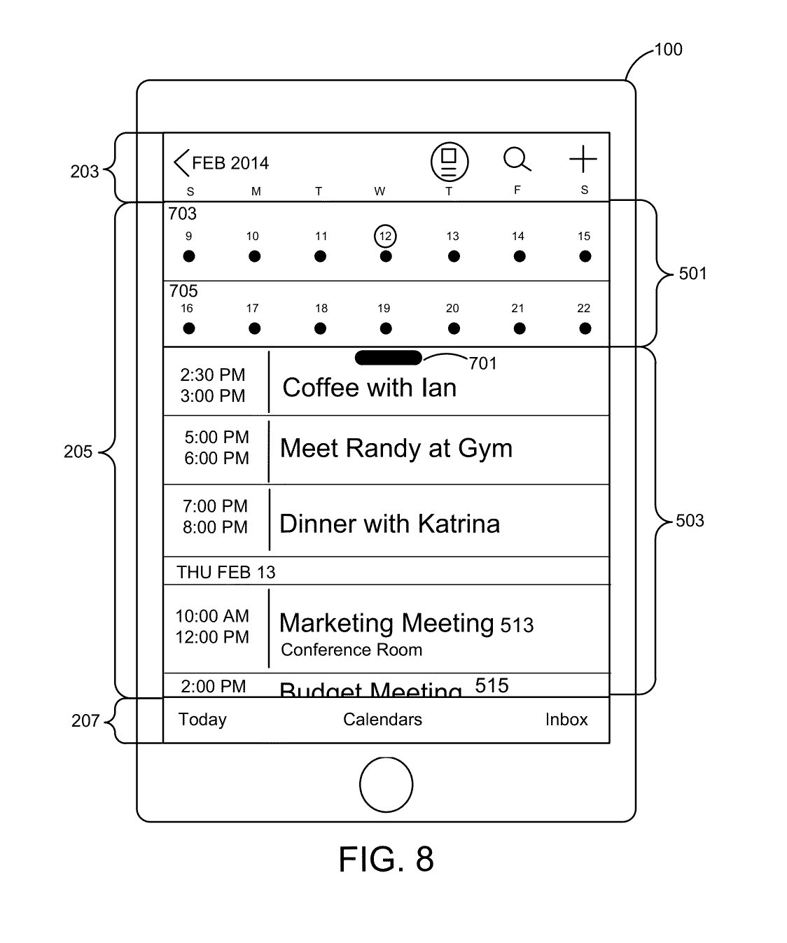

In one embodiment, if the handle 701 is moved upwards past a threshold distance, the computing device 100 updates the first content region portion 501 to display only the current week of the month as shown in FIG. 7C. In FIG. 7C, the first content region portion 501 displays only week 703. In one embodiment, the first content region portion 501 is scrollable to display other weeks of the month. For example, the user may input a horizontal swipe gesture in the first content region portion 501 to see the previous or following week depending on the direction of the gesture. The remaining area of the content region 205 is allocated to the second content display region 503 to display the list view of events. In another embodiment, the month view displayed in the first content region portion 501 and the list view of events displayed in the second content region portion 503 are not attached to each other as described with respect to FIG. 7. For example, if the user selects the handle 701 and moves it upward, the month view displayed in the first content region portion 501 decreases in size and the second content region portion 503 increases in size as shown in FIG. 8. However, as the handle 701 is moved upwards, week 707 is no longer displayed in the first content region portion 501 as if it were “covered” by the list view of events displayed in the second content region 503 as shown in FIG. 8 rather than week 703 being shifted upwards as described with respect to FIG. 7. As the handle 701 is moved upwards, the second content region portion 503 displaying the list view of events increases in size as it covers the month view displayed in the first content region portion 501 thereby exposing events 513 and 515 for the following day of Feb. 13, 2014.

### List View

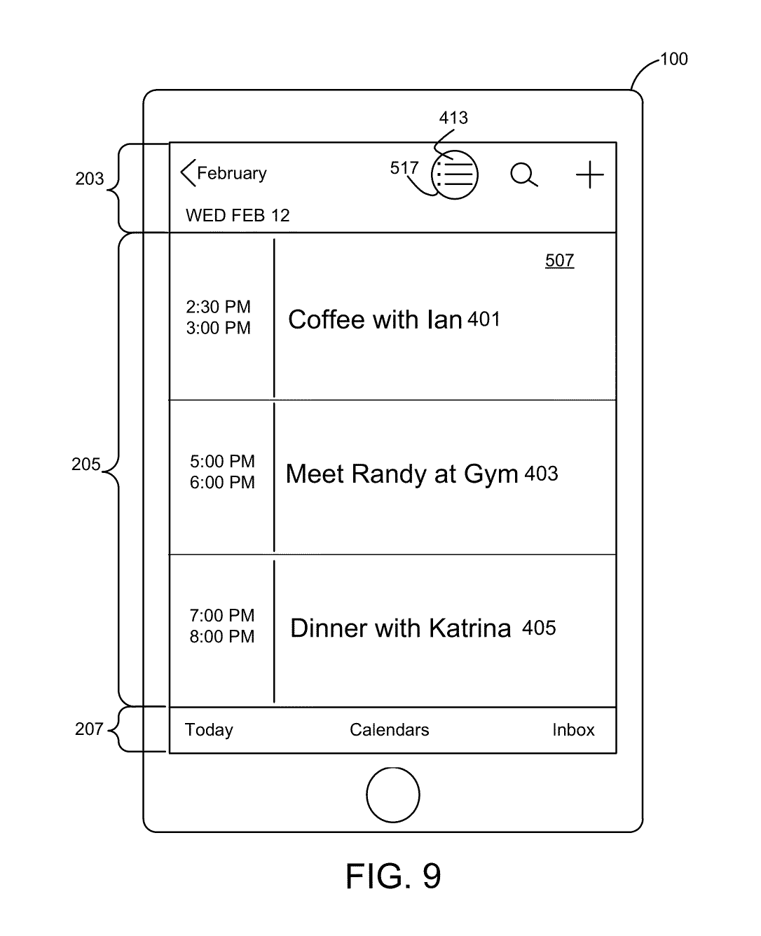

Referring back to FIG. 4 illustrating the day view 400, as mentioned previously the first control region 203 is updated to replace the split view button 215 with list view button 413 responsive to the computing device 100 displaying the day view 400. User selection of the list view button 413 causes the computing device 100 to update the content region 205 to display a list view of events rather than the day view of events as shown in FIG. 9. Furthermore, the list view button 413 is highlighted 517 indicating that the list view of events is displayed in the content region 205.

As mentioned previously, unlike the day view 400, the rows in the list of events 507 are the same size regardless of the duration of each event. Furthermore, unlike the day view 400, the list view of events 507 is continuous in that there are no visual gaps between events. In contrast, the computing device 100 visually indicates the duration of time between events in the day view 400 based on the duration of time between events whereas the list of events 507 does not include a visual indication of the duration of time between events.

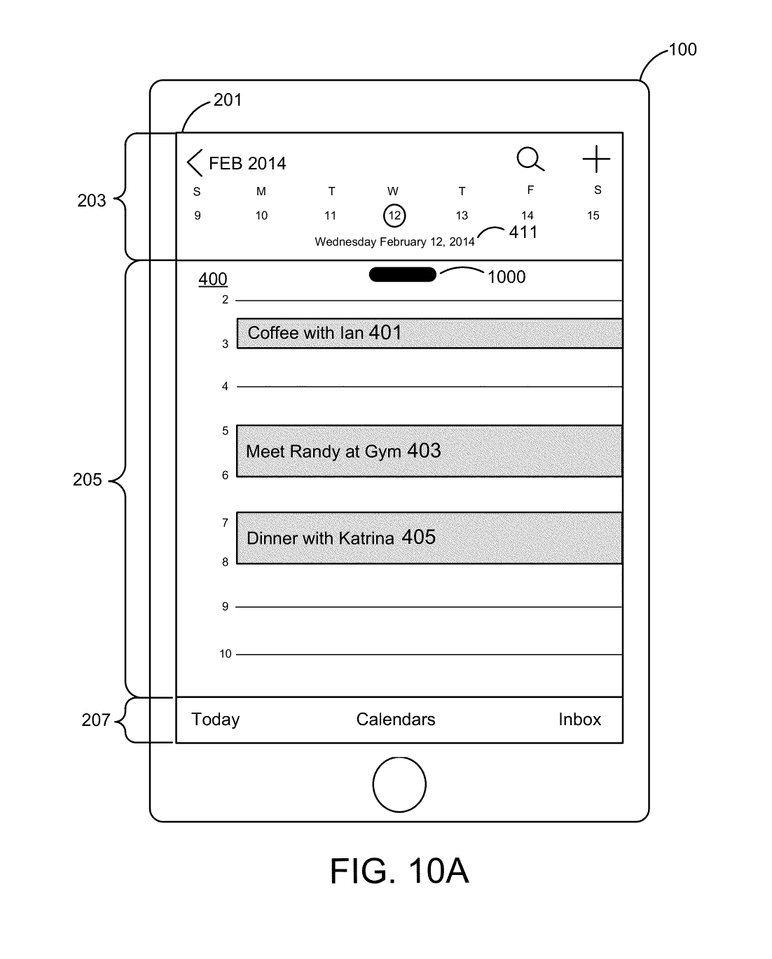

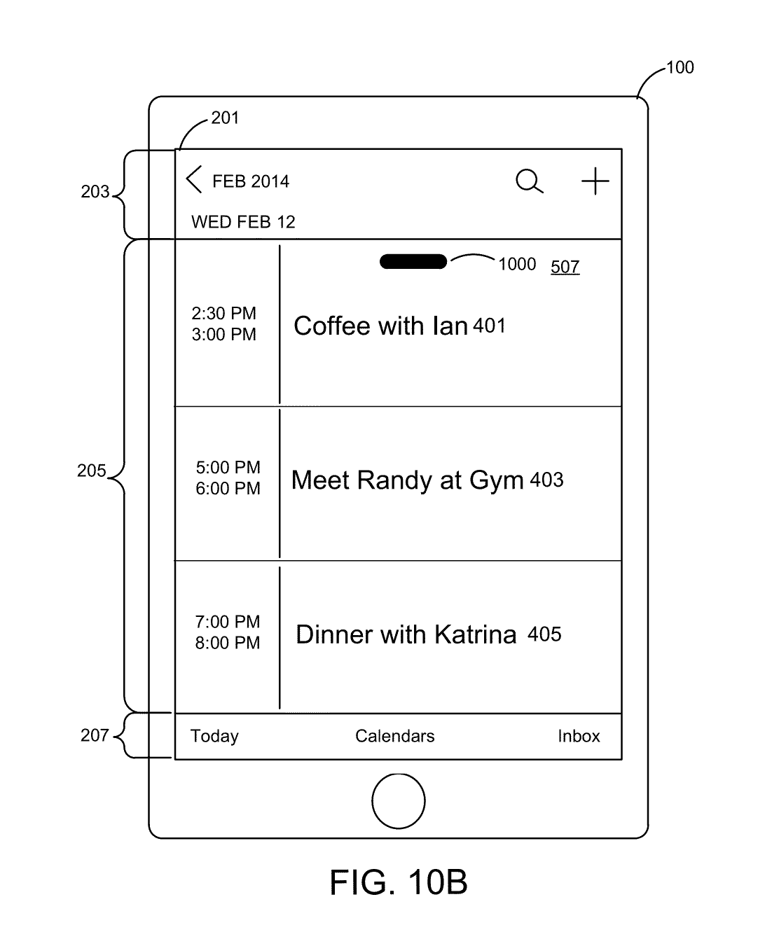

Referring to FIG. 10A, an alternative view of the day view 400 is shown. In FIG. 10A, the first control region 203 lacks the list view button 413 shown in FIG. 4 that is used to switch between displaying a day view of events 400 in the content region 205 and displaying a list view of events 507 in the content region 205. Rather, the list view button 414 is replaced with a handle 1000 located at the top of the first content region 205 under the textual description 411 displayed in the first control region 203. If the user selects the handle 1000 and moves the handle a threshold distance downward, e.g., via a swipe down gesture or a drag gesture, the day view of events 400 is updated to display a list view of events 507 as shown in FIG. 10B. Conversely, if the user selects the handle 1000 and moves the handle a threshold distance downward, via the swipe down gesture or a drag gesture, while the list view of events 507 is displayed, the computing devices 100 removes the list view of events 507 and displays the day view of events 400 in the content region 205.

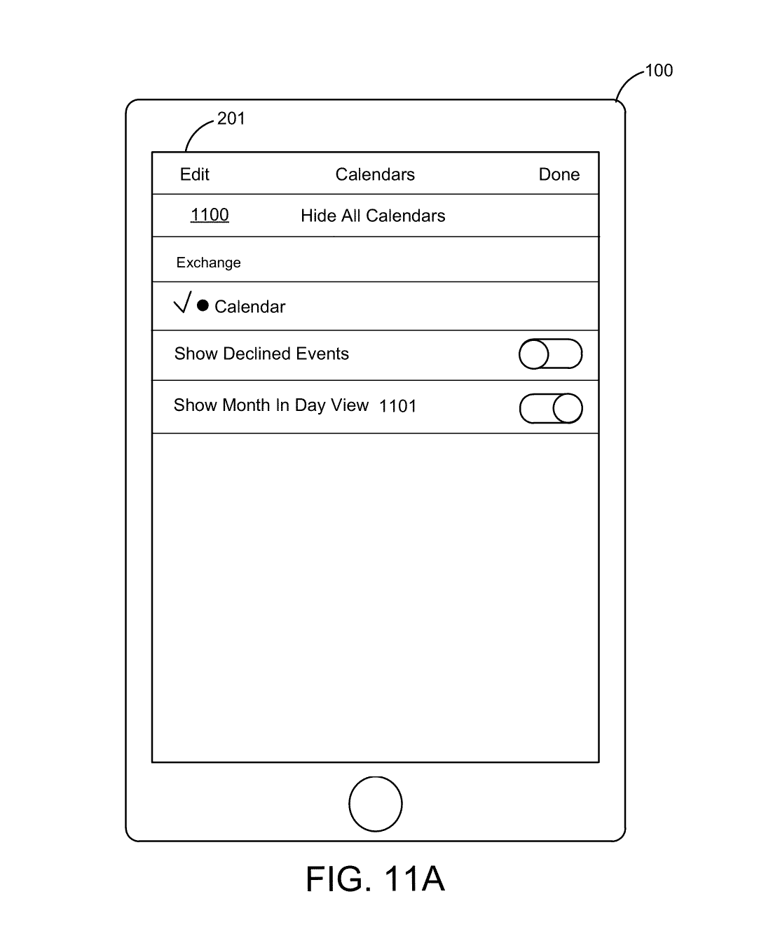

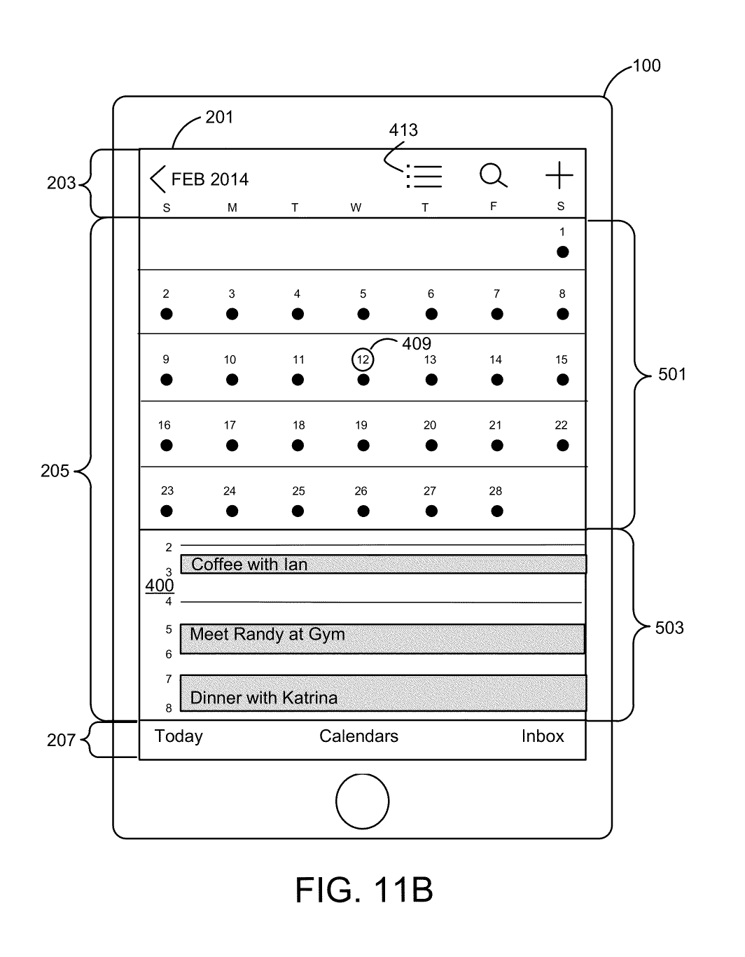

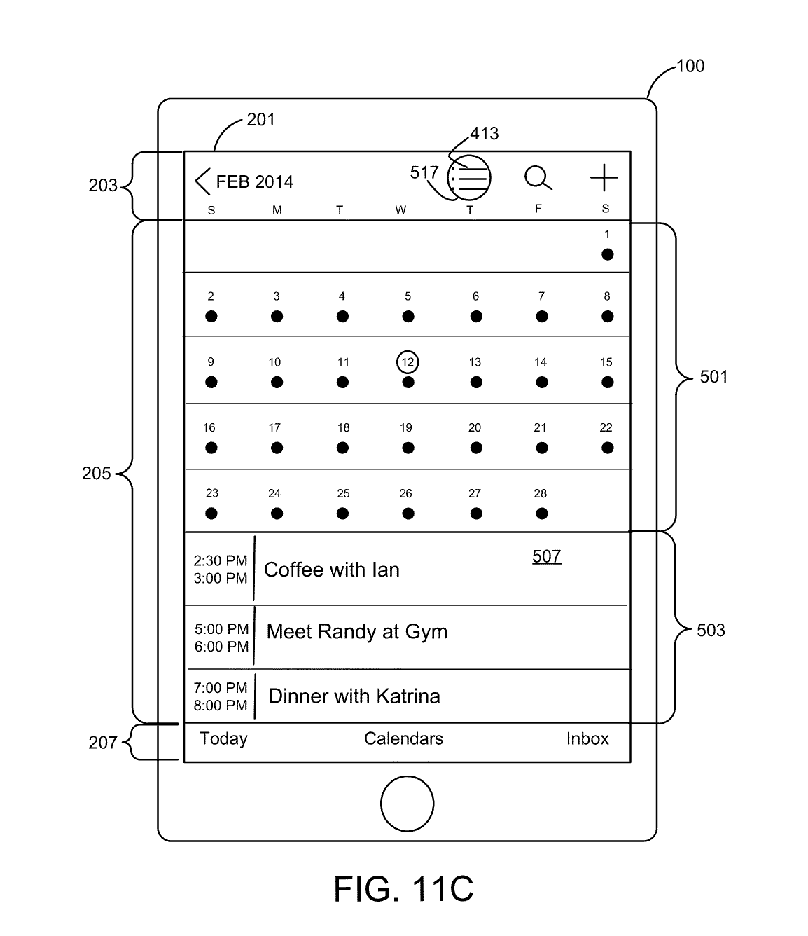

As mentioned previously, the calendars button 219 displayed in the second control region 207 activates the display of the calendar settings in the content region 205 responsive to selection of the calendars button 219. FIG. 11A is an example UI of the calendar settings 1100 displayed on the display screen 201 of the computing device 100. The calendar settings include a setting 1101 to show the month while displaying the day view of events if setting 1101 is turned on (i.e., enabled) as illustrated in FIG. 11B.

FIG. 11B is an alternative view of the day view 400. Rather than displaying the day view 400 in the entire content region 205, the content region 205 is divided into the first content region portion 501 and the second content region portion 503. The day view of events 400 is displayed in the second content region portion 501 and the entire month that includes the selected day associated with the displayed events is displayed in the first content region 501. As shown in FIG. 11B, the entire month of February 2014 is displayed in the first content region 501 with an indicator 409 of the selected day.

If the list view button 413 is selected by the user, the computing device 100 updates the second content region portion 503 to display the list view of events rather than display the day view of the events as shown in FIG. 11C. In FIG. 11C, the second content region portion 503 displays the list view of events 507 and the list view button 413 is highlighted 517 indicating that the list view is turned on. Selection of the list view button 413 while the list view is on toggles the second content region portion 503 to display the day view of the events 400.

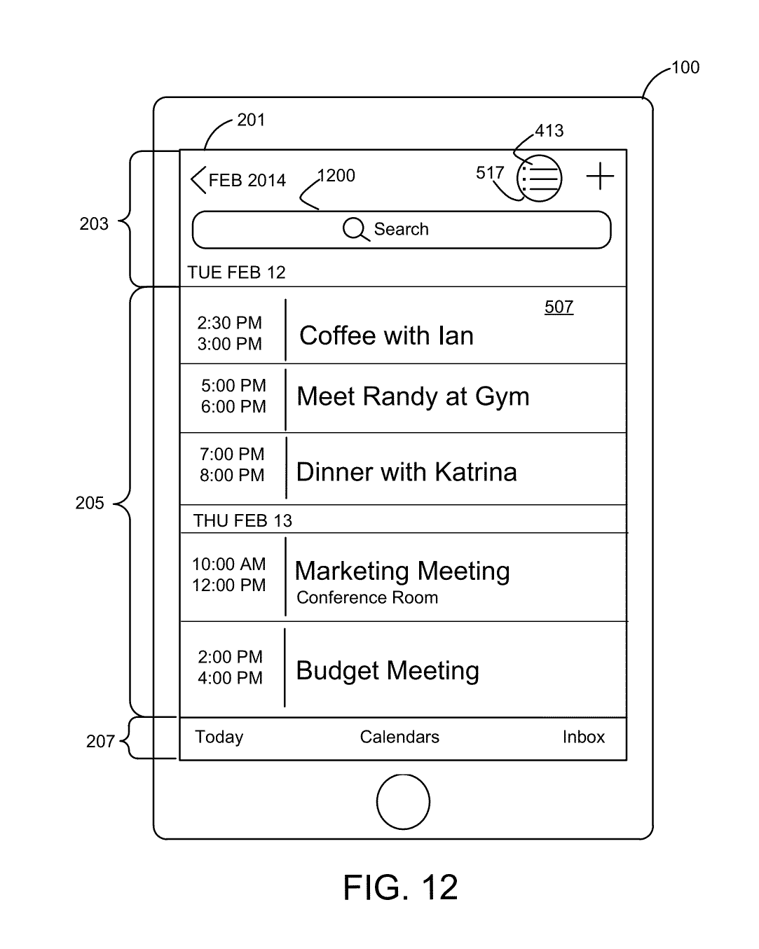

Referring now to FIG. 12, an alternative view of the list view of events 507 is shown. In one embodiment, the calendar application 101 does not include the search button 211. As shown in FIG. 12, the first control region 203 includes a text box 1200 in which search queries may be entered to identify events associated with the search queries. In one embodiment, the user may display the day view of events in the content region 205 by selecting the list view button 413 to disable the list view and enable the day view of events.

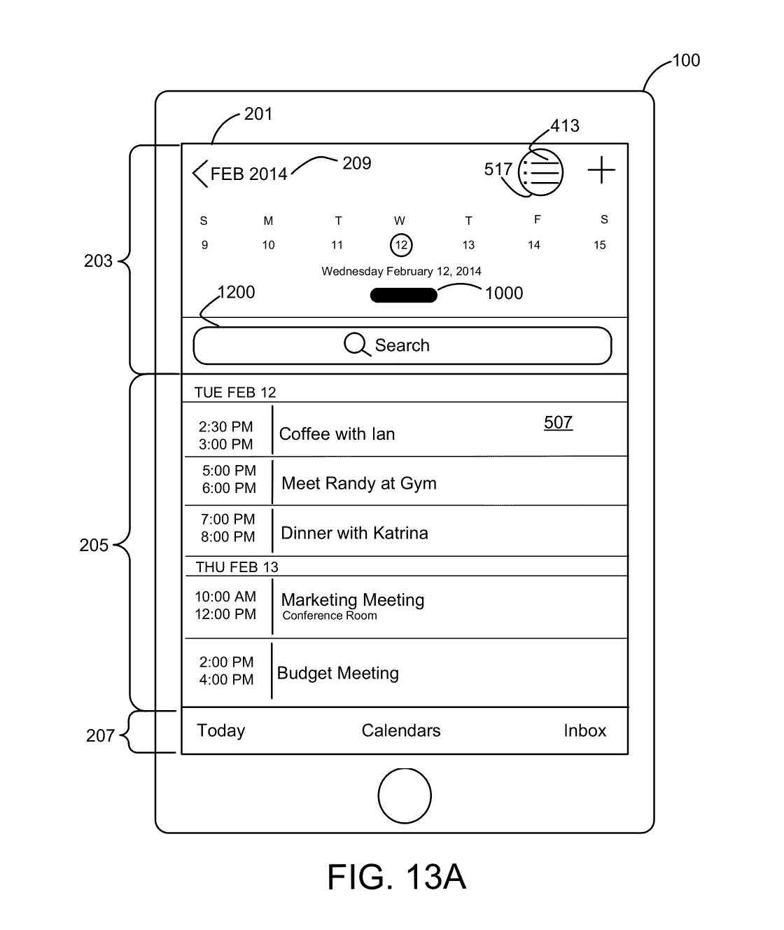

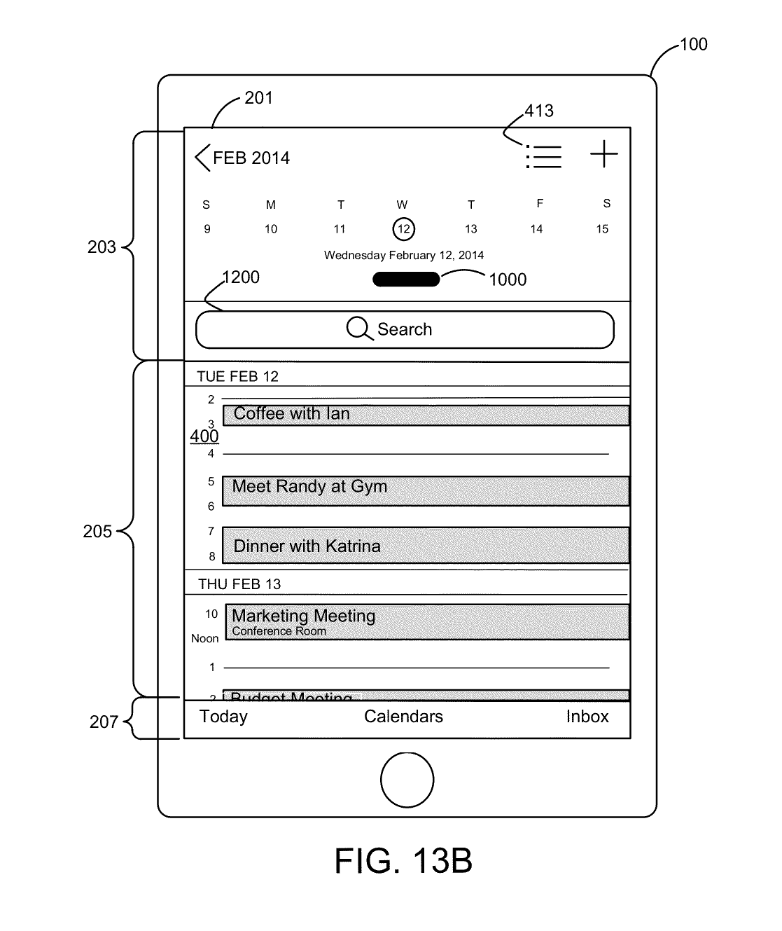

Referring now to FIG. 13A, an alternative view of the list view of events 507 is shown that does not include the search button 211. Similar to FIG. 12, a text box 1200 is included in the first control region 203 in which search queries may be entered to identify events associated with the search queries. In one embodiment, the first control region 203 also includes handle 1000. As mentioned previously, if the handle 1000 is moved a threshold distance, the content region 205 is updated to display the events in day view as shown in FIG. 13B. In FIG. 13B, the list view button 413 is no longer highlighted indicating that the list view of events is turned off.

In one embodiment, list view functionality is persistent across the calendar application 101 if the list view functionality is activated in one of the calendar views of the calendar application 101. For example, in FIG. 13A the list view is activated as indicated by the list view button 413 being highlighted 517. If the user selects the back button 209 to return to the month view 300 shown in FIG. 3 and if the user selects a particular day of the month, the computing device 100 displays the events of the selected day in list view without having to reselect the list view button 413.

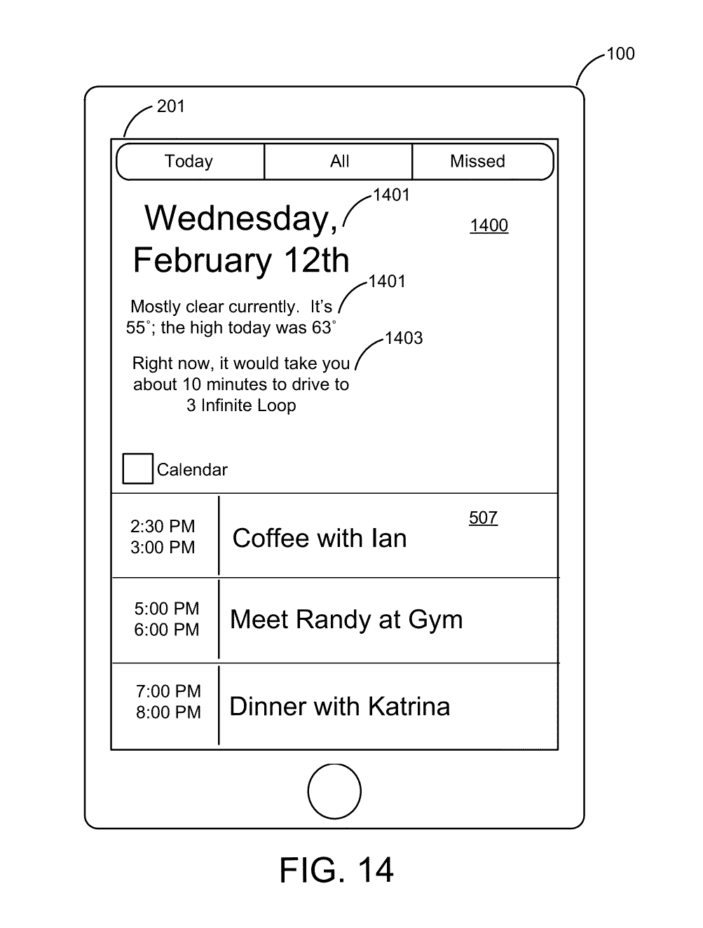

Furthermore, list view functionality is also persistent across the computing device 100 if the list view functionality is activated. FIG. 14 is a user interface of a notification center 1400 of the computing device 100 according to one embodiment. The notification center includes notifications for the user. The notifications include the current date 1401, the weather 1401 of the user's current location, and traffic information 1403. The notifications also include the user's events for the current day. As shown in FIG. 14, the events are displayed in the list view 507 because the list view functionality is enabled in the calendar application 101. If the list view functionality was disabled, the events would be displayed in the day view format.

### Method Flow Diagrams

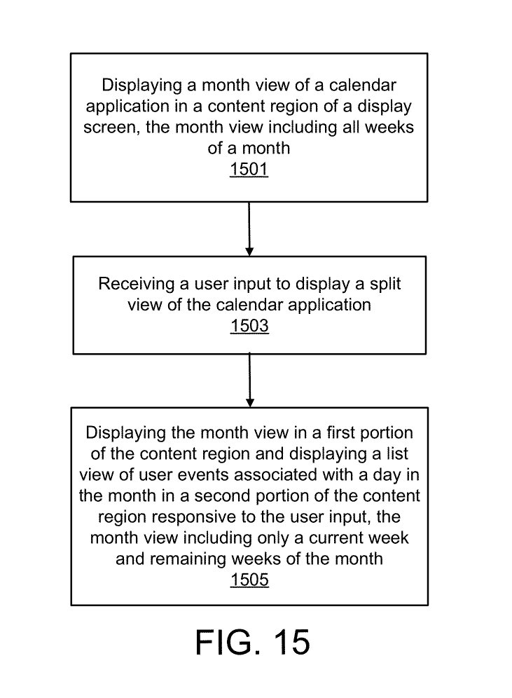

Referring now to FIG. 15, a method flow diagram is shown that describes one embodiment of displaying a calendar application. Other embodiments may include other steps than those shown in FIG. 15.

The computing device 100 displays 1501 a month view of a calendar application 101 in a content region 205 of a display screen 201 of the computing device 100. The month view includes all weeks of the month such as all the weeks in the month of February 2014. The computing device 100 receives 1503 a user input to display a split view of the calendar application 101. Responsive to the user input, the computing device 100 displays 1505 the month view in a first portion of the content region 205 and displays a list view of events associated with a day in the month view in a second portion of the content region 205. In one embodiment, the month view displayed in the first portion includes only a current week and remaining weeks of the month. Any weeks of the month prior to the current week are not displayed in split view of the calendar application 101.

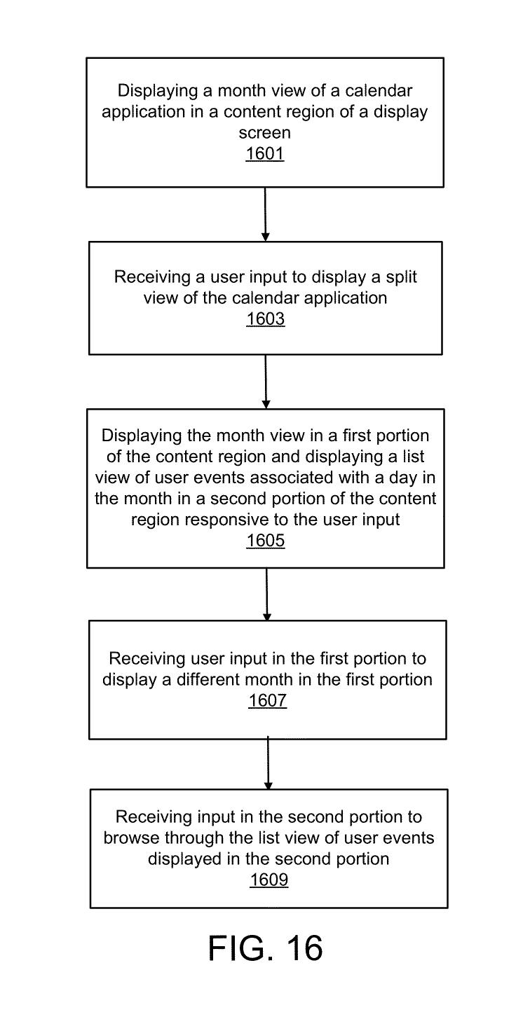

Referring now to FIG. 16, a method flow diagram is shown that describes one embodiment of displaying a calendar application. Other embodiments may include other steps than those shown in FIG. 16.

The computing device 100 displays 1601 a month view of a calendar application 101 in a content region 205 of a display screen 201 of the computing device 100. The computing device 100 receives 1603 a user input to display a split view of the calendar application 101. Responsive to the user input, the computing device 100 displays 1605 the month view in a first portion of the content region 205 and displays a list view of events associated with a day in the month view in a second portion of the content region 205. The computing device 100 receives 1607 a user input (e.g., a swipe up or swipe down gesture) in the first portion of the display screen. For example, the user may browse through different months of the year in the first portion. The computing device 100 also receives 1609 a user input (e.g., a swipe up or swipe down gesture) in the second portion to browse through the list view of events. For example, the user may browse through different events from other days in the second portion. Thus, the month view and the list view of events are separately interactable.

### Computer Diagram

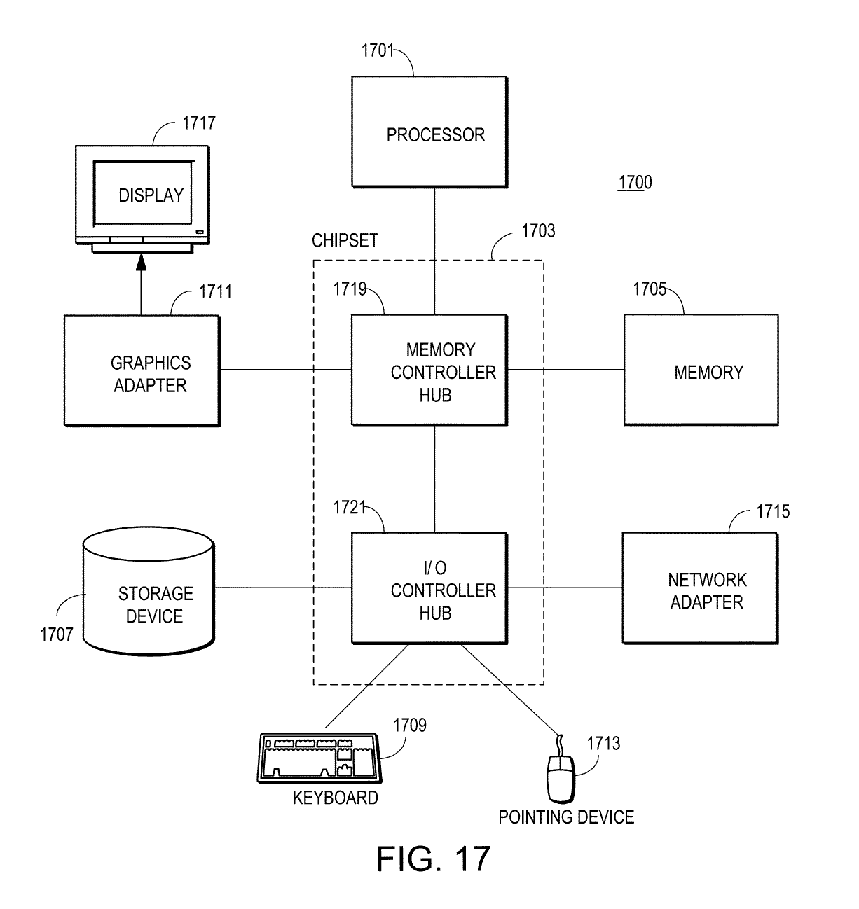

FIG. 17 is a high-level block diagram of a computer 1700 for acting as the computing device 100 according to one embodiment. Illustrated are at least one processor 1701 coupled to a chipset 1703. Also coupled to the chipset 1703 are a memory 1705, a storage device 1707, a keyboard 1709, a graphics adapter 1711, a pointing device 1713, and a network adapter 1715. A display 1717 is coupled to the graphics adapter 1711. In one embodiment, the functionality of the chipset 1703 is provided by a memory controller hub 1719 and an I/O controller hub 1721. In another embodiment, the memory 1705 is coupled directly to the processor 1701 instead of the chipset 1703.

The storage device 1707 is any non-transitory computer-readable storage medium, such as a hard drive, compact disk read-only memory (CD-ROM), DVD, or a solid-state memory device. The memory 1705 holds instructions and data used by the processor 1701. The pointing device 1713 may be a mouse, track ball, touch panel, or other type of pointing device, and is used in combination with the keyboard 1709 to input data into the computer 1700. The graphics adapter 1711 displays images and other information on the display 1717. The network adapter 1715 couples the computer 1700 to a local or wide area network.

As is known in the art, a computer 1700 can have different and/or other components than those shown in FIG. 17. In addition, the computer 1700 can lack certain illustrated components. As is known in the art, the computer 1700 is adapted to execute computer program modules for providing functionality previously described herein. In one embodiment, program modules are stored on the storage device 1707, loaded into the memory 1705, and executed by the processor 1701.

The disclosure herein has been described in particular detail with respect to one possible embodiment. Those of skill in the art will appreciate that other embodiments may be practiced. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments disclosed herein include process steps and instructions described herein in the form of an algorithm. It should be noted that the process steps and instructions could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The embodiments disclosed herein are well suited to a wide variety of computer network systems over numerous topologies. Within this field, the configuration and management of large networks includes storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure herein is intended to be illustrative, but not limiting, of the scope of the invention, which is set forth in the following claims.

What is claimed is:

1. A non-transitory computer readable storage medium storing one or more programs, the one or more programs comprising instructions, which when executed by an electronic device with a display, cause the electronic device to:
display a month view of a calendar application, the month view including a month of a year displayed in a content region of the calendar application and the month view including all weeks of the month;
receive a user input to display a split view of the calendar application; and
responsive to receiving the user input, display the month view in a first portion of the content region and displaying a list view of user events in a second portion of the content region, the month view displayed in the first portion including only a current week and remaining weeks of the month;
wherein the list view of events displayed in the second portion is organized into a continuous series of rows, each row associated with a corresponding user event from the list view of user events.

2. A non-transitory computer readable storage medium storing one or more programs, the one or more programs comprising instructions, which when executed by an electronic device with a display, cause the electronic device to:
display a month view of a calendar application, the month view including a month of a year displayed in a content region of the calendar application and the month view including all weeks of the month;
receive a user input to display a split view of the calendar application;
responsive to receiving the user input, display the month view in a first portion of the content region and displaying a list view of user events in a second portion of the content region, wherein the list view of user events displayed in the second portion are organized into a continuous series of rows, each row associated with a corresponding user event from the list view of user events;
display another month of the year in the first portion responsive to receiving a user input in the first portion to display another month; and
display at least one additional user event in the list view of user events displayed in the second portion responsive to receiving a user input in the second portion to browse user events.

3. The non-transitory computer readable storage medium of claim 2, wherein a size of each of the rows is uniform regardless of a duration of each event.

4. The non-transitory computer readable storage medium of claim 2, wherein the calendar application further includes a first control region comprising a split view user interface element and a back user interface element.

5. The non-transitory computer readable storage medium of claim 2, wherein receiving the user input to display the split view further comprises:
receiving a user selection of the split view user interface element.

6. The non-transitory computer readable storage medium of claim 2, wherein displaying the month view in the first portion and displaying the list view of user events in the second portion further comprises:
determining a size of the first content region portion based on a total number of weeks of the month to display in the first content region portion, the total number of weeks including only a current week and the remaining weeks of the month; and
dividing the content region into the first portion and the second portion based on the determined size of the first portion.

7. The non-transitory computer readable storage medium of claim 2, wherein displaying the list view of events in the second portion further comprises:
displaying all the user events in the second portion responsive to determining that each user event can be displayed in the second portion with a minimum required size; and
displaying a maximum number of user events in the second portion that can be displayed in the second portion with the minimum required size responsive to determining that all the user events cannot be displayed in the second portion with the minimum required size.

8. The non-transitory computer readable storage medium of claim 2, wherein the instructions when executed by the electronic device further cause the electronic device to:
display an animation of a name of the month displayed in the content region of the calendar application moving to the back user interface element responsive to receiving the user input indicating to display the split view.

9. The non-transitory computer readable storage medium of claim 2, wherein each row associated with a corresponding user event includes a first portion and a second portion, the first portion comprising at least a description of the user event and the second portion comprising a start time and an end time of the user event.

10. The non-transitory computer readable storage medium of claim 2, wherein displaying the list view of user events in the second portion comprises:
automatically displaying the list view of user events of a current day in the second portion of the content region responsive to receiving the user input.

11. The non-transitory computer readable storage medium of claim 2, wherein displaying the month view in the first portion of the content region comprises:
highlighting the current day in the first portion.

12. The non-transitory computer readable storage medium of claim 2, wherein the instructions when executed by the electronic device further cause the electronic device to:
receive a user selection of a day from the month view displayed in the first portion;
display an animation in the second portion of the content region to display a list view of user events of the selected day responsive to receiving the user selection; and
highlight the selected day in the first portion.

13. The non-transitory computer readable storage medium of claim 2, wherein the instructions when executed by the electronic device further causes the electronic device to:
receive a user selection of a day from the month view displayed in the first portion; and
automatically display in the second portion a list view of user events of the selected day responsive to receiving the user selection; and
highlight the selected day in the first portion.

14. The non-transitory computer readable storage medium of claim 2, wherein the instructions when executed by the electronic device further causes the electronic device to:
receive a user input in the first portion to display a different month of the year in the first portion; and
automatically update the first portion to display all weeks of the different month responsive to receiving the input.

15. The non-transitory computer readable storage medium of claim 2, wherein the instructions when executed by the electronic device further causes the electronic device to:
display a handle user interface element in either the first portion or the second portion responsive to receiving the user input indicating to display the split view;
receive a user input moving the position of the handle user interface element; and
changing the size of the first portion and a size of the second portion based on the position of the handle user interface element.

16. The non-transitory computer readable storage medium of claim 15, wherein changing the size of the first portion and the size of the second portion comprises:
decreasing the size of the first portion and increasing the size of the region portion responsive to the user input moving the position of the handle affordance in a direction towards the first portion.

17. The non-transitory computer readable storage medium of claim 15, wherein changing the size of the first portion and the size of the second portion further comprises:
increasing the size of the first portion and decreasing the size of the second portion responsive to the user input moving the position of the handle affordance in a direction away from the first portion.

18. The non-transitory computer readable storage medium of claim 15, wherein changing the size of the first portion and the size of the second portion further comprises:
removing the current week of the month displayed in the first portion and displaying an additional user event in the list view of user events displayed in the second portion responsive to the user input moving the position of the handle affordance in the direction towards the first portion.

19. The non-transitory computer readable storage medium of claim 15, wherein changing the size of the first portion and the size of the second portion further comprises:
displaying a week prior to the current week of the month in the first portion and removing a last user event displayed in the list view of user events responsive to the user input moving the position of the handle affordance in the direction away the first portion.

20. The non-transitory computer readable storage medium of claim 15, wherein changing the size of the first portion and the size of the second portion comprises:
covering a last week of the month displayed in the first portion with one or more of the user events displayed in the second portion and displaying an additional user event in the list view of user events responsive to the user input moving the position of the handle affordance in the direction towards the first portion.

21. The non-transitory computer readable storage medium of claim 15, wherein changing the size of the first portion and the size of the second portion further comprises:
displaying a week prior to the current week of the month in the first portion and covering a first user event displayed in the list view of user events with one or more weeks of the month displayed in the first portion responsive to the user input moving the position of the handle affordance in the direction away the first content region portion.

22. The non-transitory computer readable storage medium of claim 15, wherein the instructions when executed by the electronic device further causes the electronic device to:
display only the current week of the month in the first portion and increasing the size of the second portion responsive to the user input moving the position of the handle affordance in a direction towards the first portion past a predetermined threshold; and
horizontally scroll the current week of the month displayed in the first portion responsive to receiving a user input in the first portion to view other days of the weeks of the month.

23. The non-transitory computer readable storage medium of claim 22, wherein the user input in the first portion to view the other days of the weeks of the month include a tap gesture or a swipe gesture in the first portion.

24. The non-transitory computer readable storage medium of claim 4, wherein the instructions when executed by the electronic device further causes the electronic device to:
receive a selection of a day from the month view of the calendar application;
update the first control region to display days of a week and a week of the month that includes the selected day responsive to the selection;
display a day view of user events of the selected day in the content region of the calendar application responsive to the selection, wherein the day view of events is organized into rows, each row associated with a corresponding user event from the day view of user events and a size of each row is based on a duration of the user event, and wherein a distance between a pair of user events is based on a duration of time between the pair of user events.

25. The non-transitory computer readable storage medium of claim 4, wherein the instructions when executed by the electronic device further causes the electronic device to:
replace the split view affordance displayed in the first control region with a list view affordance responsive to the selection of the day; and
receive a user selection of the list view affordance;
display the list view of user events in the content region and visually highlighting the list view affordance responsive to the user selection of the list view affordance.

26. The non-transitory computer readable storage medium of claim 24, wherein displaying the day view of user events of the selected day in the content region of the calendar application further comprises:
displaying a handle user interface element in the content region;
receiving a user input moving the position of the handle user interface element past a predetermined threshold; and
updating the content region to display a list view of events of the selected day rather than the day view of events of the selected day responsive to the user input.

27. The non-transitory computer readable storage medium of claim 4, wherein the calendar application further includes a second control region including a calendar settings user interface element and wherein the instructions when executed by the electronic device further cause the electronic device to:
receive a selection of the calendar settings user interface element;
display calendar settings responsive to the selection of the calendar settings user interface element, the calendar settings including a setting to display a month in the day view of user events.

28. The non-transitory computer readable storage medium of claim 24, wherein the instructions when executed by the electronic device further cause the electronic device to:
receive a user input selecting a setting to display the month in the day view of events;
receive a selection of a day from the month view of the calendar application;
display all weeks of the month including the selected day in the first portion of the content region and displaying a day view of user events of the selected day in the second portion responsive to the selection; and
display a list view of user events of the selected day in the second portion responsive to receiving a user selection of the list view affordance.

29. The non-transitory computer readable storage medium of claim 4, wherein the first control region further includes an area to include a search query.

30. The non-transitory computer readable storage medium of claim 2, wherein the instructions when executed by the electronic device further cause the electronic device to:
receive a user request to display a notification view of the computer device; and
display the notification view including a plurality of notifications for the user, the plurality of notifications comprising a list view of user events of a current day responsive to the user selection of the list view affordance displayed in the first control region.

31. A computer-implemented method for displaying a calendar application, the method comprising:
displaying, on a computing device, a month view of a calendar application, the month view including a month of a year displayed in a content region of the calendar application and the month view including all weeks of the month;
receiving a user input to display a split view of the calendar application;
responsive to receiving the user input, displaying the month view in a first portion of the content region and displaying a list view of user events in a second portion of the content region, wherein the list view of user events displayed in the second portion are organized into a continuous series of rows, each row associated with a corresponding user event from the list view of user events;
displaying another month of the year in the first portion responsive to receiving a user input in the first portion to display another month; and
displaying at least one additional user event in the list view of user events displayed in the second portion responsive to receiving a user input in the second portion to browse user events.

32. An electronic device comprising:
a display;
one or more processors;
memory; and
one or more programs, wherein the one or more programs are stored in the memory and configured to be executed by the one or more processors, the one or more programs including instructions when executed by the electronic device cause the electronic device to:
display a month view of a calendar application, the month view including a month of a year displayed in a content region of the calendar application and the month view including all weeks of the month;
receive a user input to display a split view of the calendar application;
responsive to receiving the user input, display the month view in a first portion of the content region and displaying a list view of user events in a second portion of the content region, wherein the list view of user events displayed in the second portion are organized into a continuous series of rows, each row associated with a corresponding user event from the list view of user events;
display another month of the year in the first portion responsive to receiving a user input in the first portion to display another month; and
display at least one additional user event in the list view of user events displayed in the second portion responsive to receiving a user input in the second portion to browse user events.
